(19) United States
(12) Patent Application Publication
(10) Pub. No.: US 2020/0236516 A1
(43) Pub. Date: Jul. 23, 2020

(54) COMMUNICATION CHARGING SYSTEM AND COMMUNICATION CHARGING METHOD

(71) Applicant: Panasonic Intellectual Property Management Co., Ltd., Osaka (JP)

(72) Inventors: Osamu KATO, Fukuoka (JP); Hiroaki ASANO, Kanagawa (JP); Yasuhiro AOYAMA, Tokyo (JP); Hideki KANEMOTO, Kanagawa (JP)

(21) Appl. No.: 16/650,177

(22) PCT Filed: Aug. 30, 2018
(86) PCT No.: PCT/JP2018/032275

§ 371 Date: Mar. 24, 2020

(30) Foreign Application Priority Data
Sep. 25, 2017 (JP) 2017-184216

(51) Int. Cl. H04W 4/24; H04M 15/00

(52) U.S. Cl. CPC H04W 4/24; H04M 2215/32; H04M 15/58

(57) ABSTRACT

A communication charging system includes a first measuring device that measures an amount of communication established by a terminal in utilization of a first communication service using a first communication network and a second measuring device that measures an amount of communication established by the terminal in utilization of a second communication service using a second communication network. The first measuring device transmits information regarding the measured amount of communication in the utilization of the first communication service to the second measuring device. The second measuring device associates with information regarding the terminal and stores the information regarding the amount of communication in the utilization of the first communication service, which has been transmitted from the first measuring device, and information regarding the measured amount of communication in the utilization of the second communication service.

### TECHNICAL FIELD

The present disclosure relates to a communication charging system and a communication charging method for managing the amount of wireless communication established by a terminal and charging for the communication, and the terminal that performs the wireless communication.

### BACKGROUND ART

In 5G (fifth generation mobile communication system), utilization of a high-frequency band such as a millimeter wave band has been considered, and such a high-frequency band is considered to be suitable for accommodating wireless communication traffics in indoor areas (for example, individual houses, housing complexes, hotels, and hospitals) and local areas (for example, shopping malls, company sites, construction sites, university campuses, and smart towns). A terminal owned by a user may be connected to a wide-range cellular base station in an outdoor area (in other words, a public area) that is not included in an indoor area or a local area as described above and transmit and receive data in some cases or may be connected to a base station that covers a relatively small space in an indoor area or a local area as described above and transmit and receive data in other cases.

A 5G wireless communication system that covers an indoor area or a local area can provide high-bit per second (bps) services using a relatively small number of small-sized and reasonable base stations (for example, home teleconference, uploading of monitor camera movies, and downloading and viewing paid content movies) to terminals, the number of which is limited to some extent. However, a current wide-range cellular system is not provided with a function of distinguishing, counting, and managing in which area wireless communication traffics have been generated, and a P-GW (packet data network gateway; PDN-GW) that is included in a core network of the wide-range cellular system measures and manages the total amount of traffics in the wireless communication for each terminal.

For example, Non-patent Literature 1 provides the following proposal (that is, a proposal of flexible accounting) in regard to measuring and management of the total amount of traffics in wireless communication for each terminal in consideration of advantageous utilization of 5G wireless communication. Specifically, even in a case in which a user has subscribed to an existing specific wide-range cellular communication service provider, a terminal of the user performs wireless communication using another frequency band handled by another wide-range cellular communication service provider if condition of the wireless communication with the wide-range cellular communication service provider to which the user has already subscribed is not satisfactory and communication is thus disconnected. In this manner, it is expected that the user is smoothly charged in accordance with the amount of traffics in the wireless communication that the terminal has performed for each wide-range cellular communication service provider even if there is no subscription contract between the user who owns the terminal and the wide-range cellular communication service provider.

In addition, it is also assumed that a plurality of communication service providers share the same frequency band (in other words, a shared frequency (shared band: SB) for using a high-frequency band such as a millimeter wave band in 5G. If advantageous utilization of the shared frequency is expected, it is estimated that an existing wide-range cellular communication service provider or a newcomer solution provider that provide communication services in the aforementioned local area appear. It is considered that in a case in which 28 GHz band is a shared frequency, for example, a newcomer solution provider provides a necessary number of 28 GHz band base stations in a local area (see above) that is assumed to be a target of provision of communication services and starts to provide a service of accommodating wireless communication traffics in the local area within the 28 GHz band. In this case, it is considered that the solution provider establishes a business model of obtaining corresponding values from customers (for example, owners of shopping malls, managers of company sites, most responsible persons at construction sites, university administrators, and administrating companies of smart towns) by providing total additional values including wireless communication to the local areas.

### CITATION LIST

### Non-Patent Literature

Non-Patent Literature 1: 5GMF White Paper “5G Mobile Communications Systems for 2020 and beyond Version 1.01”, 5GMF (The Fifth Generation Mobile Communications Promotion Forum), Jul. 4, 2016

### SUMMARY OF INVENTION

### Technical Problem

However, according to the related art including Non-Patent Literature 1, the following negative effects may occur if the measurement is performed without distinguishing the amount of data transmitted and received through wide-range cellular base station connection of a communication service provider that a user who owns a terminal subscribes, the amount of data transmitted and received through indoor area base station connection of the same communication service provider, and the amount of data transmitted and received through local area base station connection of the same communication service provider, respectively. Specifically, it is not possible to individually set communication rates in accordance with capital investment for base stations required by the communication service provider to provide the communication service. Therefore, there is no other option for the communication service provider to set a bit unit price in wireless communication traffics to an intermediate value of appropriate values for an outdoor area, an indoor area, and in a local area, and it is difficult to distribute the communication service in each of the outdoor service, the indoor service, and the local area service.

Specifically, if it is not possible to set such a bit unit price that a user can receive the indoor service without worrying about the communication rate too much, this may interrupt the distribution of the indoor service that the communication service provider provides. Also, if it is not possible to set such a bit unit price that the user can receive the local area service without worrying about the communication rate too much, this may interrupt the distribution of the local area service that the communication service provider provides. Moreover, if excessive occurrence of communication traffics is not prevented through appropriate expensive charging for a terminal who generates a large number of communication traffics in the service area, the communication traffics exceed system capacity, and communication quality is degraded as a whole.

In addition, the local area service is a communication service in an area where an area owner is present, such as a stadium, a theme park, a school campus, or a subway station, for example. Therefore, it is also conceivable that a newcomer solution provider instead of an existing wide-range cellular communication service provider places base stations and provides a communication service. In a case in which a user uses a terminal in a university building, for example, charging of a communication rate for communication traffics communicated via a base station of a solution provider for a shared frequency and charging of a communication rate for communication traffics communicated via a base station of a wide-range cellular communication service provider are separately managed. However, the user cannot receive the communication service from the solution provider without worrying about the communication rate unless the user cannot know to which of the base station the terminal is connected in advance, and this may interrupt distribution of the local area service using the shared frequency.

The present invention was contrived in view of the aforementioned circumstances in the related art, and an object thereof is to provide a communication charging system and a communication charging method that measures and manages the amount of communication in accordance with wireless communication traffics for each communication service that a terminal owned by a user has used, realizes appropriate charging for the communication service in accordance with a status during the utilization, and thus effectively supports distribution of utilization of the communication service to users.

The present disclosure was contrived in view of the aforementioned circumstances in the related art, and an object thereof is to provide a terminal that presents information regarding a communication rate of a communication service that a user starts to use to the user in advance, and allows the user to recognize the information regarding the communication rate before starting the utilization, and thus effectively supports distribution of utilization of the communication service to users.

### Solution to Problem

The present disclosure provides a communication charging system including: a first measuring device that measures an amount of communication established by a terminal in utilization of a first communication service using a first communication network; and a second measuring device that measures an amount of communication established by the terminal in utilization of a second communication service using a second communication network, in which the first measuring device transmits information regarding the measured amount of communication in the utilization of the first communication service to the second measuring device, and the second measuring device associates with information regarding the terminal and stores, in a storage unit, the information regarding the amount of communication in the utilization of the first communication service, which has been transmitted from the first measuring device, and information regarding the measured amount of communication in the utilization of the second communication service.

Also, the present disclosure provides a communication charging method using a communication charging system that includes a first measuring device and a second measuring device, in which the first measuring device measures an amount of communication established by a terminal in utilization of at least one first communication service using a first communication network, the second measuring device measures an amount of communication established by the terminal in utilization of at least one second communication service using a second communication network, the first measuring device transmits information regarding the measured amount of communication in the utilization of the first communication service to the second measuring device, and the second measuring device associates with information regarding the terminal and stores, in a storage unit, the information regarding the amount of communication in the utilization of the first communication service, which has been transmitted from the first measuring device, and information regarding the measured amount of communication in the utilization of the second communication service.

Also, the present disclosure provides a communication charging system including: a first measuring device that measures an amount of communication established by a terminal in utilization of a first communication service using a first communication network; and a second measuring device that measures an amount of communication established by the terminal in utilization of a second communication service using a second communication network, in which the first measuring device associates and stores, in a first storage unit, information regarding the measured amount of communication in the utilization of the first communication service with information regarding the terminal, and the second measuring device associates and stores, in a second storage unit, information regarding the measured amount of communication in the utilization of the second communication service with the information regarding the terminal.

Also, the present disclosure provides a communication charging method using a communication charging system that includes a first measuring device and a second measuring device, in which the first measuring device measures an amount of communication established by a terminal in utilization of a first communication service using a first communication network, the second measuring device measures an amount of communication established by the terminal in utilization of a second communication service using a second communication network, the first measuring device associates and stores, in a first storage unit, information regarding the measured amount of communication in the utilization of the first communication service with information regarding the terminal, and the second measuring device associates and stores, in a second storage unit, information regarding the measured amount of communication in the utilization of the second communication service with the information regarding the terminal.

Also, the present disclosure provides a terminal including: an operation unit that receives an instruction for starting utilization of a first communication service using a first communication network; a communication unit that transmits information regarding the first communication service indicated in the instruction to a service station device that provides the first communication service; an acquisition unit that acquires charging structure information indicating a correspondence between an amount of communication and a communication rate in the utilization of the first communication service, which has been generated by the service station device based on the information regarding the first communication service, via the communication unit; and a display unit that displays a permission selecting screen for start of the utilization of the first communication service, which includes the acquired charging structure information corresponding to the first communication service, in which the communication unit starts communication regarding the first communication service with the service station device in response to an instruction for permitting the start of the utilization of the first communication service, which has been provided to the permission selecting screen for the start of the utilization of the first communication service.

### Advantageous Effects of Invention

According to the present disclosure, it is possible to measure and manage the amount of communication in accordance with wireless communication traffics for each communication service that a terminal owned by a user has used, to thereby realize appropriate charging for the communication services in accordance with statuses during the utilization, and to effectively support distribution of utilization of the communication services to users.

According to the present disclosure, it is possible to present, to a user, information regarding communication rates of communication services that the user starts to use in advance, to allow the user to recognize the information regarding the communication rates before the start of the utilization, and to effectively support distribution of utilization of the communication services to users.

### BRIEF DESCRIPTION OF DRAWINGS

FIG. 1 is a block diagram illustrating a system configuration example of a communication charging system according to an embodiment.

FIG. 2 is a block diagram illustrating an example of an internal configuration of a local cellular network according to the embodiment in detail.

FIG. 3 is a diagram illustrating an example of an application charging structure table for managing a charging structure for communication for each application.

FIG. 4 is a block diagram illustrating an example of an internal configuration of a terminal according to the embodiment in detail.

FIG. 5 is a sequence diagram illustrating an example of signaling for each communication service that the terminal has used, in the communication charging system according to the embodiment.

FIG. 6 is a diagram illustrating an example of an application selecting screen to be displayed on a terminal display unit of the terminal and an example of an application start permission selecting screen corresponding to a selected application according to the embodiment, respectively.

FIG. 7 is a diagram illustrating candidate examples of communication service providers, communication services, and charging structures to be displayed on the application start permission selecting screen illustrated in FIG. 6.

FIG. 8 is a block diagram illustrating a system configuration example of a communication charging system according to a modification example of the embodiment.

FIG. 9 is a sequence diagram illustrating an example of signaling for each communication service that a terminal in the communication charging system has used according to the modification example of the embodiment.

### DESCRIPTION OF EMBODIMENTS

Hereinafter, an embodiment that specifically discloses a communication charging system, a communication charging method, and a terminal according to the present disclosure will be described in detail appropriately with reference to drawings. However, detailed description more than necessity may be omitted. For example, detailed description of matters that have already been known well or repeated description of substantially the same configuration may be omitted. This is for avoiding the following description becoming unnecessarily redundant and for facilitating understanding of those skilled in the art. Also, the accompanying drawings and the following description are to provide sufficient understanding of the present disclosure to those skilled in the art and are not intended to limit the subject matters described in the claims.

### Embodiment

In an embodiment, a case in which a communication service provider who is a subject of providing a communication service that can be used in a wide cellular network WCNW, which will be described later, collectively performs billing of a communication rate that is caused due to utilization of a communication service that the communication service provider itself runs and billing of a communication rate that is caused due to utilization of a communication service that can be used in a local cellular network LCNW will be described as an example.

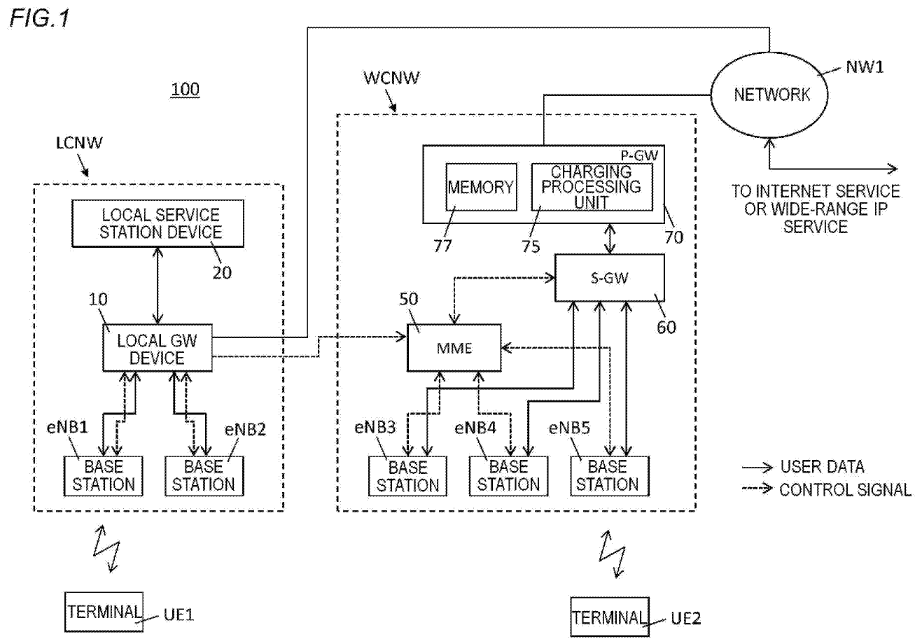

FIG. 1 is a block diagram illustrating a system configuration example of a communication charging system 100 according to the embodiment. In FIG. 1, the solid line represents communication of user data, and the dotted line represents communication of control signals. The communication charging system 100 has a configuration including the local cellular network LCNW and the wide cellular network WCNW. Both the local cellular network LCNW and the wide cellular network WCNW are connected to a variety of communication service providing web servers (not illustrated) that provide internet services (an example of the second communication service) or wide-range internet protocol (IP) services (an example of the second communication service) via the network NW 1. The network NW1 is an Internet network or a wide-range IP service network, for example, that connects the aforementioned various communication service providing web servers (not illustrated) to the local cellular network LCNW or the wide cellular network WCNW in a wireless manner.

Terminals UE1 and UE2 that a plurality of different users that use the communication charging system 100 (hereinafter, simply referred to as “users”) respectively own can establish wireless connection to any of the local cellular network LCNW and the wide cellular network WCNW. FIG. 1 illustrates an example in which the terminal UE1 is connected to the local cellular network LCNW in a wireless manner and the terminal UE2 is connected to the wide cellular network WCNW in a wireless manner. Also, although only the two terminals are illustrated in FIG. 1 for simplifying the drawing, the number of terminals that can establish wireless connection to any of the local cellular network LCNW and the wide cellular network WCNW is not limited two.

The local cellular network LCNW has a configuration including a plurality of base stations (for example, base stations eNB1 and eNB2), a local gateway (GW) device 10, and a local service station device 20. The base stations, the local GW device 10, and the local service station device 20 are respectively configured using server devices that are computers, for example. Also, the number of base stations placed in the local cellular network LCNW is not limited to two.

The local cellular network LCNW (an example of the first communication network) is a local network constructed on the assumption of utilization in an indoor area (for example, an individual home, a home complex, a hotel, or a hospital) or a local area (for example, a shopping mall, a company site, a construction site, a university campus, or a smart town), for example. The local cellular network LCNW accommodates traffics of wireless communication performed by a terminal (for example, the terminal UE1) in a local area or an indoor area. In other words, the terminal performs wireless communication by placing greater priority on base stations (for example, the base stations eNB1 and eNB2) included in the local cellular network LCNW than on base stations (for example, any of base stations eNB3, eNB4, and eNB5) included in the wide cellular network WCNW, in an area in which the local cellular network LCNW is constructed in consideration of a standpoint of traffic offload.

A frequency band used for the wireless communication in the local cellular network LCNW is, for example, 28 GHz that has been considered to be used for a high-frequency band (for example, 5G (fifth generation mobile communication system)). The 28 GHz band is a frequency band that has been considered to have a probability of being used as a frequency band (that is, a shared frequency) to be shared by a plurality of communication service providers (for example, an existing wide-range cellular communication service provider and a newcomer solution provider). In the embodiment, the local cellular network LCNW may be run by either an existing wide-range cellular communication service provider or a communication service provider that is a newcomer solution provider, for example. However, it is needless to say that the frequency band used for wireless communication in the local cellular network LCNW is not limited to the aforementioned 28 GHz band.

Each of the base stations eNB1 and eNB2 relays communication between the terminal UE1 and the local GW device 10 when a communication service (specifically, a communication service that is provided by the local service station device 20) that can be used in the local cellular network LCNW is provided to the terminal UE1. Internal configurations of the base stations eNB1 and eNB2 are, for example, known configurations, and detailed description thereof will be omitted in the embodiment. Each of the base stations eNB1 and eNB2 executes wireless communication in accordance with a wireless standard specification that is the same as that of the terminal UE1 when wireless communication with the terminal UE1 is performed.

The local cellular network LCNW may not be a C/U separation-type network or may be a C/U separation-type network. In the embodiment, the network that is not of a C/U separation type will be described as an example. That is, in the local cellular network LCNW, wireless communication of control signals and wireless communication of user data, which are performed with the terminal UE1, are performed by the base station eNB1 or the base station eNB2 that is the same as the base station that have established wireless connection with the terminal UE1.

The base stations eNB1 and eNB2 are small-cell base stations that can provide high-speed throughputs based on the aforementioned 28 GHz band and are deployed at a high density. Also, each of the base stations eNB1 and eNB2 is deployed, for example, in an individual home, a home complex, a hotel, a hospital, a shopping mall, a company site, a construction site, a university campus, a stadium, a large conference room in an international conference site, or a smart town. The terminal communicates control signals and communicates user data with any of the small cell base stations. The control signals include data regarding a control (C)-plane. The user data includes data regarding user (U)-plane. The user data includes, for example, image data (for example, a video or a stationary image) and a sound data and can include data of a large data amount.

The C-plane is a communication protocol for communicating control signals for call connection and terminal movement management in wireless communication. The U-plane is a communication protocol for actually performing communication (for example, video communication, sound communication, or data communication) using assigned wireless resources between the terminal and the base stations eNB1 and eNB2.

Cell radii of the base stations eNB1 and eNB2 are 10 m to 100 m, for example, and are relatively smaller than those of macro-cells provided by the base stations eNB3, eNB4, and eNB5 included in the wide cellular network WCNW.

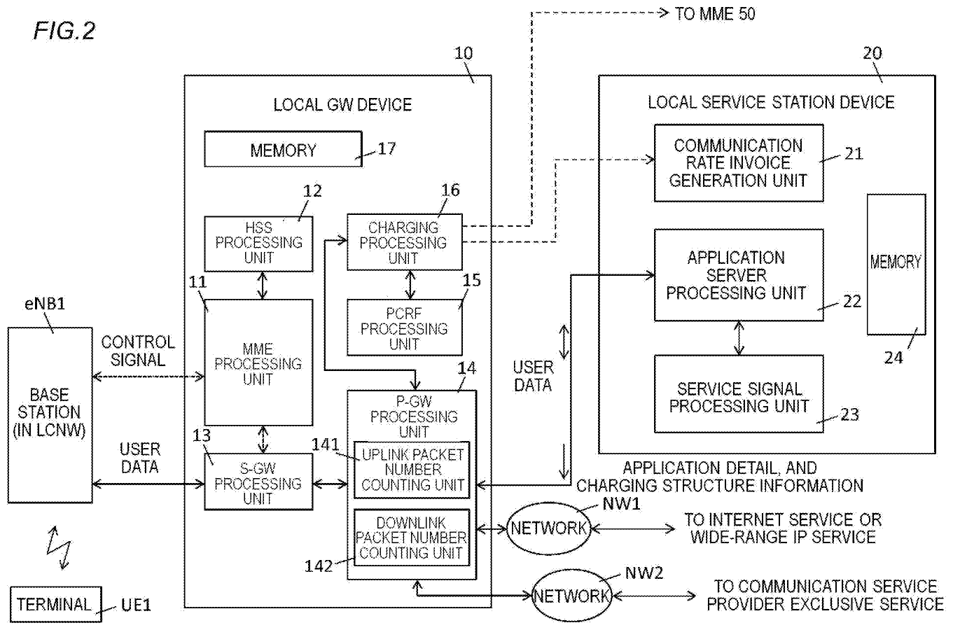

The local GW device 10 serves as a gateway device that relays wireless communication between the local service station device 20 that provides a communication service that can be used in the local cellular network LCNW and each of the base stations eNB1 and eNB2. For example, the local GW device 10 measures and manages the amount of communication in wireless communication established by each terminal when the communication service provided by the local service station device 20 provides is used (specifically, the amount of communication indicating the total number of packets on uplink and the amount of communication indicating the total number of packets on downlink) for each terminal. Details of the internal configuration of the local GW device 10 will be described later with reference to FIG. 2.

The local service station device 20 provides a communication service that can be used in the local cellular network LCNW. Although types of communication service that can be provided by the local service station device 20 in the local cellular network LCNW are preferably limited to specific communication services in accordance with characteristics such as a location of an indoor area or a local area where the local cellular network LCNW has been constructed, the number of users, and the like, the types may not be limited in particular. If an instruction for starting utilization of some communication service is provided to the terminal through a user's operation, the local service station device 20 receives information regarding the communication service indicated by the instruction via a base station (for example, a base station eNB1) and the local GW device 10. The local service station device 20 generates charging structure information including a communication service provider as a subject that provides the communication service and a communication rate when the communication service is used, on the basis of the received information regarding the communication service and replies the charging structure information to the terminal. Also, the local service station device 20 generates information of the communication rate corresponding to the amount of communication of each terminal (hereinafter, referred to as “LC charging information”) on the basis of the amount of wireless communication measured by the local GW device 10 for each terminal. Details of the internal configuration of the local service station device 20 will be described later with reference to FIG. 2.

The wide cellular network WCNW has a configuration including a plurality of base stations (for example, the base stations eNB3, eNB4, and eNB5), a mobility management entity (MME) 50, a serving gateway (S-GW) 60, and a packet data network gateway (P-GW) 70. Each of the base stations, the MME 50, the S-GW 60, and the P-GW 70 is configured using a server device that is a computer, for example. Also, the number of base stations placed in the wide cellular network WCNW is not limited to 3.

The wide cellular network WCNW (an example of the second communication network) is a core network that is constructed on the assumption of utilization in an outdoor area that does not correspond to the aforementioned indoor area or local area, for example (in other words, a public area). The wide cellular network WCNW accommodates traffics of wireless communication that a terminal (for example, the terminal UE2) performs in the aforementioned outdoor area. In other words, since the terminal cannot establish wireless connection to the base stations (for example, the base stations eNB1 and eNB2) that are included in the local cellular network LCNW outside the area in which the local cellular network LCNW is constructed (that is, in an outdoor area), the terminal establishes wireless connection to a base station (for example, any of the base stations eNB3, eNB4, and eNB5) included in the wide cellular network WCNW.

It is conceivable that a frequency band used for wireless communication in the wide cellular network WCNW is a frequency band (for example, a 2 GHz band or a 4 GHz band) that is rather lower than the frequency band used for wireless communication in the local cellular network LCNW in a mainstream. In the embodiment, the wide cellular network WCNW is run by an existing a wide-range cellular communication service provider similarly to 3G (a third generation mobile communication system) or 4G (a fourth generation mobile communication system) such as long term evolution (LTE), for example. However, the frequency band used for the wireless communication in the wide cellular network WCNW is not limited to the aforementioned 28 GHz band and may be 3G (a third generation mobile communication system), 4G (a fourth generation mobile communication system) such as long term evolution (LTE), or both 3G and 4G.

Each of the base stations e NB3, e NB4, and e NB5 relays communication of control signals and user data between the terminal UE2 and the network NW1 when the communication service that can be used in the wide cellular network WCNW is provided to the terminal UE2. Specifically, the communication service that can be used in the wide cellular network WCNW is an internet service or a wide-range IP service provided by various communication service providing web servers (not illustrated) connected via the network NW1. Internal configurations of the base stations eNB3, eNB4, and eNB5 are known configurations, for example, and detailed description thereof will be omitted in the embodiment. Each of the base stations eNB3, eNB4, and eNB5 executes wireless communication in accordance with a wireless standard specification that is the same as that of the terminal UE2 when each of the base stations eNB3, eNB4, and eNB5 performs wireless communication with the terminal UE2.

Also, the respective base stations eNB3, eNB4, and eNB5 may be base stations that are compatible with a plurality of different wireless communication schemes (for example, a radio access technology (RAT) or a cell radius). The radio access technology (RAT) includes, for example, information regarding a wireless communication standard and a wireless frequency. The wireless communication standard may be, for example, long term evolution (LTE), a wireless local area network (LAN), a digital enhanced cordless telecommunication (DECT), 3G (third generation mobile communication system), or 4G (fourth generation mobile communication system).

The wide cellular network WCNW may not be a C/U separation-type network or may be a C/U separation-type network. In the embodiment, the network that is not of a C/U separation type will be described as an example. That is, in the wide cellular network WCNW, wireless communication of the control signals and wireless communication of the user data, which are performed with the terminal UE2, are performed by any one of the base stations eNB3, eNB4, and eNB5 that are the same and in wireless connection to the terminal UE2.

Also, the communication service that a terminal (for example, the terminal UE1) can use in the local cellular network LCNW and the communication service that a terminal (for example, the terminal UE1) can use in the wide cellular network WCNW may be different from each other or may be the same. In a case in which the communication services that can be used in both the networks are different, in particular, the P-GW 70 can collectively bill the user of the terminal for the respective communication rates corresponding to the amounts of packet communication based on utilization of the different communication services using the different networks, it is possible to improve convenience in processing of charging the user.

A terminal (for example, the terminal UE2) communicates control signals and communicates user data through wireless communication with the base stations eNB3, eNB4, and eNB5. The control signals include data regarding a control (C)-plane. The user data includes data regarding user (U)-plane. The user data includes, for example, image data (for example, a video or a stationary image) and a sound data and can include data of a large data amount.

The C-plane is a communication protocol for communicating control signals for called connection and wireless resource assignment in wireless communication. The U-plane is a communication protocol for actually performing communication (for example, video communication, sound communication, and data communication) using the assigned wireless resources between the terminal and the base stations eNB3, eNB4, and eNB5.

A terminal (for example, the terminal UE2) and the base stations eNB3, eNB4, and eNB5 set radio access technologies (RAT) used for wireless communication from among radio access technologies (RAT; wireless communication standards or wireless frequencies, for example) that each of the terminal and the base stations eNB3, eNB4, and eNB5 can employ and perform wireless communication using the set radio access technologies (RAT). Each of the terminal (for example, the terminal UE2) and the base stations eNB3, eNB4, and eNB5 can employ one or more radio access technologies (RAT). As specific information for the radio access technologies (RAT), RAT1 to RAT5 below, for example, are included. RAT1 is LTE with a frequency band of 700 MHz to 3 GHz, for example. RAT2 is LTE-Advanced with a frequency band of 1.5 GHz, for example. RAT3 is wireless LAN communication of a frequency band of 5 GHz, for example. RAT4 is a wireless communication scheme with a frequency band of 1.5 GHz and is a fifth generation mobile communication scheme. RAT5 is a wireless communication scheme (for example, millimeter wave communication) with a frequency band of 60 GHz, for example (for example, WiGig).

The MME 50 intervenes between the S-GW 60 and various base stations (for example, the base stations eNB3, eNB4, and eNB5), accommodates the base stations included in the wide cellular network WCNW, and control establishment and releasing of wireless connection in the wide cellular network WCNW of the terminal (for example, the terminal UE2). The MME 50 manages position registration and movement of the terminal (for example, the terminal UE2) that establishes wireless connection to the wide cellular network WCNW and cooperates with a home subscriber server (HSS; not illustrated) to authenticate the terminal (for example, security control) and processing of setting a user data transfer route.

Also, the MME 50 receives LC charging information (see the following description) indicating the amount of communication in utilization of the communication service in the local cellular network LCNW for each terminal (for example, the terminal UE1) owned by a user, which has been transmitted as a control signal from the local service station device 20. The MME 50 transfers the received LC charging information for each terminal to the P-GW 70 via the S-GW 60.

The S-GW 60 accommodates user data that various base stations (for example, the base stations eNB3, eNB4, and eNB5) have received from the terminal (for example, the terminal UE2) in the wide cellular network WCNW and transfers the user data to the P-GW 70. Also, the S-GW 60 relays a control signal for wireless communication between the MME 50 and the P-GW 70.

The P-GW 70 has a charging processing unit 75 and a memory 77, is connected in a wired manner (connected using an optical fiber, for example) with various communication service providing web servers (not illustrated) that provides Internet services or wide-range IP services, transmits user data transferred from the S-GW 60 to the network NW1, and transfers user data transferred from the network NW1 to the S-GW 60. The P-GW 70 assigns an IP address to a terminal that accesses the wide cellular network WCNW, authenticates the terminal, performs quality-of-service (QoS) control, and generates charging information in accordance with a policy and charging rule function (PCRF).

The P-GW 70 measures the amount of wireless communication established by the terminal in utilization of the communication service provided using the wide cellular network WCNW (specifically, the amount of communication indicating the total number of packets on uplink and the amount of communication indicating the total number of packets on downlink), saves the amount of communication in the memory 77, and manages the amount of communication, for each terminal.

The charging processing unit 75 calculates a communication rate corresponding to the amount of communication on the basis of a result of measuring the amount of wireless communication established by the terminal in the utilization of the communication service provided using the wide cellular network WCNW (specifically, the amount of communication indicating the total number of packets on uplink and the amount of communication indicating the total number of packets on downlink) for each terminal and the charging structure information of the communication service, generates the result of calculation as WC charging information, saves the WC charging information in the memory 77, and manages the WC charging information. Also, the charging processing unit 75 may not be provided in the P-GW 70 or may be implemented as a device that is separated from the P-GW 70, for example.

The memory 77 is implemented using a random access memory (RAM) and a read only memory (ROM), for example, and holds programs and data required to execute various kinds of processing performed by the P-GW 70. Also, the memory 77 temporarily saves data or information (for example, information indicating the amount of communication measured by the charging processing unit 75) generated in the processing performed by the P-GW 70.

FIG. 2 is a block diagram illustrating an example of an internal configuration of the local cellular network LCNW according to the embodiment in detail. In FIG. 2, the solid line represents communication of user data, and the dotted line represents communication of control signals. Also, communication interface (I/F) units for communication with communication counterparts are omitted in the local GW device 10 and the local service station device 20 in FIG. 2.

The local GW device 10 has a configuration including an MME processing unit 11, an HSS processing unit 12, an S-GW processing unit 13, a P-GW processing unit 14, a PCRF processing unit 15, a charging processing unit 16, and a memory 17. The MME processing unit 11, the HSS processing unit 12, the S-GW processing unit 13, the P-GW processing unit 14, and the PCRF processing unit 15, and the charging processing unit 16 are implemented using processors such as central processing units (CPU), micro processing units (MPU), digital signal processors (DSP), or field-programmable gate arrays (FPGA), for example.

The MME processing unit 11 accommodates base stations included in the local cellular network LCNW between the local service station device 20 and various base stations (for example, the base stations eNB1 and eNB2) and controls establishment and releasing of wireless connection of the terminal (for example, the terminal UE1) in the local cellular network LCNW. The MME processing unit 11 manages position registration and movement of the terminal (for example, the terminal UE1) that is connected to the local cellular network LCNW in a wireless manner and performs processing of setting a transfer route of user data.

The HSS processing unit 12 manages user identification information including an identification number such as a phone number, a subscriber identity module (SIM), or the like of the terminal, for example, for each terminal owned by each user.

The S-GW processing unit 13 accommodates user data received by various base stations (for example, the base stations eNB1 and eNB2) from the terminal (for example, the terminal UE1) in the local cellular network LCNW and transfers the user data to the P-GW processing unit 14. Also, the S-GW processing unit 13 relays a control signal for wireless communication between the MME processing unit 11 and the P-GW processing unit 14.

The P-GW processing unit 14 assigns an IP address to a terminal that accesses the local cellular network LCNW and authenticates the terminal. The P-GW processing unit 14 transfers user data transferred from the S-GW processing unit 13 to the local service station device 20 and transfers user data or charging structure information transmitted from the local service station device 20 to the S-GW processing unit 13.

In addition, the P-GW processing unit 14 is connected in a wired manner (connected using an optical fiber, for example) with various communication service providing web servers (not illustrated) that provide Internet services or wide-range IP services via the network NW1, transmits user data transferred from the S-GW processing unit 13 to the network NW1, and transfers user data transferred from the network NW1 to the S-GW processing unit 13.

Also, the P-GW processing unit 14 has an uplink packet number counting unit 141 and a downlink packet number counting unit 142 measures and manages the amount of communication (the number of packets used for wireless communication, for example) in utilization of the communication service provided by the local service station device 20 to the terminal that accesses the local cellular network LCNW. In the embodiment, 1 packet corresponds, for example, to 128 bytes.

The uplink packet number counting unit 141 measures and manages the amount of communication (that is, the amount of communication indicating the total number of packets on uplink) in utilization of an uplink in a communication service provided by the local service station device 20 to a terminal (for example, the terminal UE1) that accesses the local cellular network LCNW.

The downlink packet number counting unit 142 measures and manages the amount of communication (that is, the amount of communication indicating the total number of packets on downlink) in utilization of a downlink in a communication service provided by the local service station device 20 to a terminal (for example, the terminal UE1) that accesses the local cellular network LCNW.

The PCRF processing unit 15 holds and manages charging structure information (for example, a charging rule (policy and charging rule function)) for generating charging information corresponding to the amount of communication in utilization of each communication service that can be provided by the local service station device 20 in the local cellular network LCNW. The PCRF processing unit 15 shares the charging structure information with the charging processing unit 16.

The charging processing unit 16 calculates and generates charging information corresponding to the amount of communication for each terminal in accordance with charging structure information for each communication service on the basis of the amount of communication for each terminal measured by the P-GW processing unit 14 and the charging structure information (for example, a charging rule) for each communication service shared with the PCRF processing unit 15. The charging processing unit 16 saves the generated charging information (LC charging information) for each terminal in the memory 17 and manages the charging information and transmits the charging information (LC charging information) for each terminal to the local service station device 20 or the MME 50 of the wide cellular network WCNW.

The memory 17 is implemented using a RAM and a ROM, for example, and holds programs and data required to execute various kinds of processing performed by the local GW device 10. In addition, the memory 17 temporarily saves the charging information (LC charging information) for each terminal generated by the charging processing unit 16.

The local service station device 20 has a configuration including a communication rate invoice generation unit 21, an application server processing unit 22, a service signal processing unit 23, and a memory 24. The communication rate invoice generation unit 21, the application server processing unit 22, and the service signal processing unit 23 are implemented using processors such as CPUs, MPUs, DSPs, or FPGAs, for example.

The communication rate invoice generation unit 21 receives and acquires the charging information (LC charging information) for each terminal transmitted from the charging processing unit 16 of the local GW device 10. The communication rate invoice generation unit 21 generates, for each terminal, detailed statement data of the communication rate charged on the user who has used the communication service that can be provided by the local service station device 20 in the local cellular network LCNW on the basis of the acquired LC charging information for each terminal. A predetermined format, for example, is defined for the detailed statement data of the communication rate (that is, invoice data). The communication rate invoice generation unit 21 transmits the generated detailed statement data of the communication rate for each terminal to the local GW device 10. The detailed statement data of the communication rate for each terminal transmitted from the communication rate invoice generation unit 21 is acquired by the charging processing unit 16 of the local GW device 10.

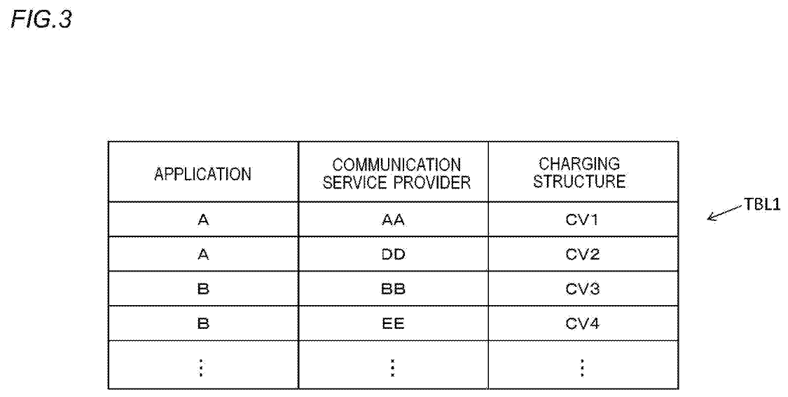

The application server processing unit 22 manages information regarding a communication service (specifically, an application) that is executed by the service signal processing unit 23 and can be provided in the local cellular network LCNW and manages charging structure information for generating the charging information corresponding to the amount of communication in utilization of each communication service (application) (see FIG. 3). Specifically, the application server processing unit 22 reads, from the memory 24, an application charging structure table TBL1 illustrated in FIG. 3 and acquires detailed information of the application displayed on an application start permission selecting screen displayed on the terminal and charging structure information that accompanies utilization of the application. The application server processing unit 22 transmits the acquired detailed information of the application and the charging structure information that accompanies the utilization of the application in an associated manner to the local GW device 10. The detailed information of the application and the charging structure information that accompanies the utilization of the application are transmitted to the terminal (for example, the terminal UE1) via the local GW device 10 and the base station (for example, the base station eNB1).

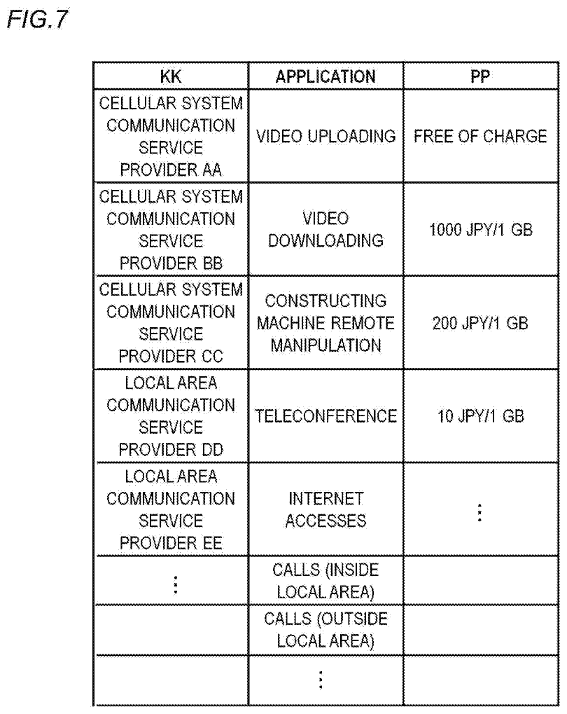

FIG. 3 is a diagram illustrating an example of the application charging structure table TBL1 for managing a charging structure in communication of each application. In the application charging structure table TBL1, information of the application and information of a communication service provider that provides a communication service of the application are saved with information of the charging structure in an associated manner. Also, charging structures CV1, CV2, CV3, and CV4 are, for example, free of charge, 1000 JPY/1 GB (gigabyte), 200 JPB/1 GB, and 10 JPY/1 GB (see FIG. 7).

For example, an application A can be provided by two different communication service providers AA and DD, respectively. The communication service provider AA predefines the charging structure CV1 for generating charging information corresponding to the amount of communication in utilization of the application A. In other words, the charging structure CV1 is applied to utilization of the application A provided by the communication service provider AA according to the application charging structure table TBL1. Meanwhile, the communication service provider DD predefines the charging structure CV2 for generating charging information corresponding to the amount of communication in utilization of the application A. In other words, the charging structure CV2 is applied to the utilization of the application A provided by the communication service provider DD according to the application charging structure table TBL1. The charging structures CV1 and CV2 are typically different from each other since the communication service providers as providing sources are different from each other.

Similarly, the application B, for example, can be provided by two different communication service providers BB and EE. The communication service provider BB predefines the charging structure CV3 for generating charging information corresponding to the amount of communication in utilization of the application B. In other words, the charging structure CV3 is applied to the utilization of the application B provided by the communication service provider BB according to the application charging structure table TBL1. Meanwhile, the communication service provider EE predefines the charging structure CV4 for generating charging information corresponding to the amount of communication in utilization of the application B. In other words, the charging system CV4 is applied to the utilization of the application B provided by the communication service provider EE according to the application charging structure table TBL1. The charging structures CV3 and CV4 are typically different from each other since the communication service providers as providing sources are different from each other.

The service signal processing unit 23 has an application execution processing function capable of providing one or more communication services (specifically, applications) that can be used by a terminal in the local cellular network LCNW. The service signal processing unit 23 generates various kinds of data or information required to provide the communication services using captured video data transmitted from an external device (not illustrated; a monitor camera, for example) in accordance with details of the communication services, for example.

In a case in which the communication service is a monitoring service using a monitor camera, for example, the service signal processing unit 23 generates video data (an example of user data) adapted to a predetermined format and transmits the video data to the local GW device 10 via the application server processing unit 22 in order to provide captured video data transmitted from an external device (for example, any monitor camera among a plurality of monitor cameras, for example) to the terminal.

In a case in which the communication service is a service for viewing a free-viewpoint video of a sport stadium, for example, the service signal processing unit 23 generates video data (an example of user data) of a free-viewpoint video adapted to request from a terminal on the basis of captured video data transmitted from a plurality of external devices (a plurality of monitor cameras, for example) and transmits the video data to the local GW device 10 via the application server processing unit 22.

In a case in which the communication service is a remote manipulation service for a constructing machine deployed in a construction site, for example, the service signal processing unit 23 establishes remote communication with the corresponding constructing machine, generates a corresponding command for ordering remote manipulation on the basis of a manipulation instruction transmitted from the terminal, controls the processing of the constructing machine in a remote manner, generates a result of the remote control processing (an example of user data), and transmits the result to the local GW device 10 via the application server processing unit 22.

In a case in which the communication service is a service for viewing charged video content such as movies, for example, the service signal processing unit 23 receives video data of the charged video content transmitted from one or more external servers (not illustrated) that distribute charged video content adapted to a request from the terminal and transmits the video data (an example of user data) to the local GW device 10 via the application server processing unit 22.

The memory 24 is implemented using a RAM and a ROM, for example, and holds programs and data required to execute various kinds of processing performed by the local service station device 20. In addition, the memory 24 temporarily saves detailed statement data of a communication rate for each terminal generated by the communication rate invoice generation unit 21. Also, the memory 24 serves as a work memory that temporarily saves data or information in the processing performed by the service signal processing unit 23.

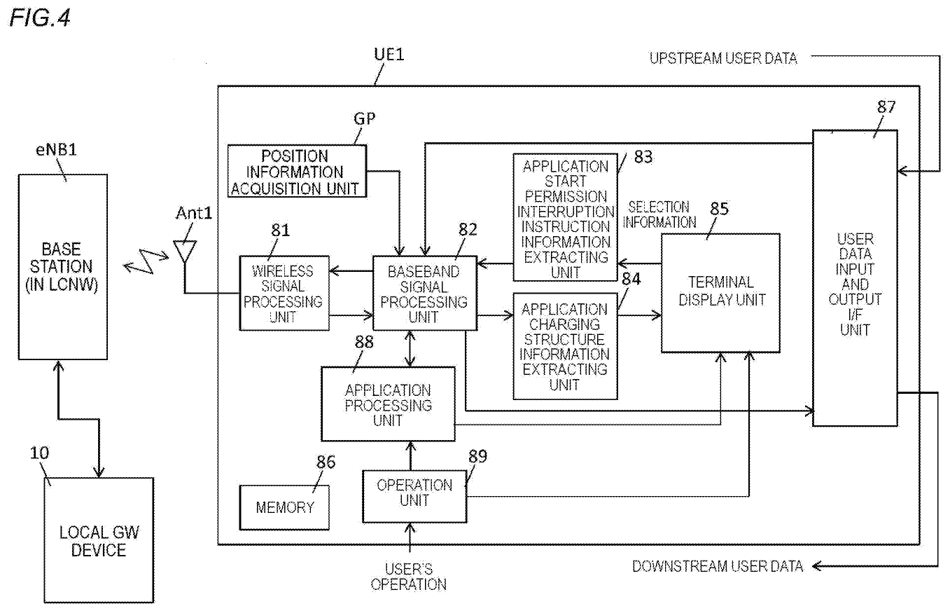

FIG. 4 is a block diagram illustrating an example of an internal configuration of the terminal UE1 according to the embodiment in detail. The terminal UE1 is a mobile-type communication device owned by a user, for example, and is a smartphone or a tablet terminal, for example. Also, the terminal UE1 is not limited to the smartphone or the tablet terminal. Although FIG. 4 is illustrated by exemplifying the terminal UE1, an internal configuration of the terminal that accesses the communication charging system 100 according to the embodiment is also similar to the illustrated configuration as well as the terminal UE2 illustrated in FIG. 1.

The terminal UE1 has a configuration including a wireless signal processing unit 81, a baseband signal processing unit 82, an application start permission/interruption instruction information extracting unit 83, an application/charging structure information extracting unit 84, a terminal display unit 85, a memory 86, a user data input and output I/F unit 87, an application processing unit 88, and an operation unit 89. The terminal UE1 may further include a position information acquisition unit GP. The baseband signal processing unit 82, the application start permission/interruption instruction information extracting unit 83, the application/charging structure information extracting unit 84, the user data input and output I/F unit 87, and the application processing unit 88 are implemented using processors such as CPUs, MPUs, DSPs, or FPGAs, for example.

The wireless signal processing unit 81 performs transmission and reception of a wireless signal of a frequency band used in the local cellular network LCNW with a base station (for example, the base station eNB1) via an antenna Ant1. Also, although not illustrated in FIG. 4, the wireless signal processing unit 81 may perform transmission and reception of a wireless signal of a frequency band used in the wide cellular network WCNW with a base station (for example, the base station eNB3) via the antenna Ant1.

The baseband signal processing unit 82 converts the wireless signal received by the wireless signal processing unit 81 into a signal of a baseband bandwidth. Also, the baseband signal processing unit 82 converts the signal of the baseband bandwidth input to the baseband signal processing unit 82 into a wireless signal of the frequency band handled by the wireless signal processing unit 81.

The application start permission/interruption instruction information extracting unit 83 extracts selection information indicating whether to permit or interrupt start of a corresponding application on the basis of a user's operation performed on the application start permission selecting screen displayed on the terminal display unit 85 and outputs the selection information to the baseband signal processing unit 82. The selection information is transmitted to the local GW device 10 via the baseband signal processing unit 82, the wireless signal processing unit 81, the antenna Ant1, and the base station (for example, the base station eNB1).

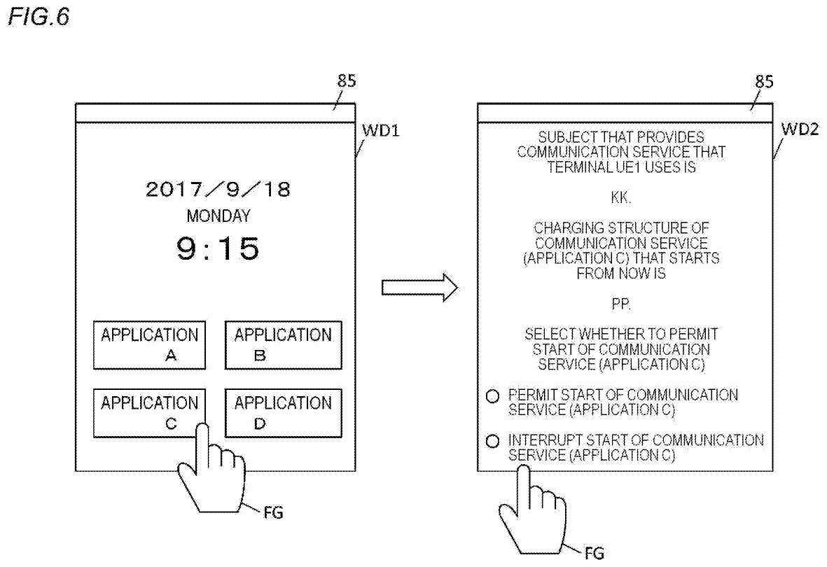

The application/charging structure information extracting unit 84 extracts the detailed information of the application and the charging structure information that accompanies the utilization of the application transmitted from the local service station device 20 on the basis of a user's operation for providing an instruction for starting utilization of the application. The application/charging structure information extracting unit 84 generates the application start permission selecting screen using the extracted detailed information and the charging structure information that accompanies the utilization of the application and displays the detailed information and the charging structure information on the terminal display unit 85. The application start permission selecting screen displayed on the terminal display unit 85 will be described later with reference to FIG. 6.

The terminal display unit 85 is implemented using a liquid crystal display (LCD) or an organic electroluminescence (EL), for example, and displays a screen including various kinds of data or information. The terminal display unit 85 sends information regarding the position of the terminal display unit 85 indicated by an instruction provided through a user's operation using the operation unit 89 as selection information to the application start permission/interruption instruction information extracting unit 83 when the screen including various data or information is displayed.

The memory 86 is implemented using a RAM and a ROM, for example, and holds programs and data required to execute various kinds of processing performed by the terminal UE1. Also, the memory 86 temporarily saves the various kinds of data or information displayed by the terminal display unit 85. In addition, the memory 86 temporarily saves the position information of the terminal UE1 calculated by the position information acquisition unit GP. The memory 86 serves as a work memory that temporarily saves the data or the information when each part included in the terminal UE1 executes processing.

The user data input and output I/F unit 87 inputs upstream user data (for example, uploaded captured video data) input from an external device (for example, one or more monitor devices) and outputs downstream user data (for example, downloaded captured video data) to an external device (for example, a display device).

The application processing unit 88 is a processing unit that activates, executes, interrupts, and ends any of applications designated through a user's operation using the operation unit 89. The application is installed in an executable manner in the terminal UE1 (see FIG. 6). In a case in which an instruction for starting utilization of any of the applications is provided through a user's operation using the operation unit 89, for example, the application processing unit 88 acquires information regarding the application indicated by the instruction and outputs the information to the baseband signal processing unit 82 in order for the application start permission selecting screen to be displayed on the terminal display unit 85. The information regarding the application is transmitted to the local service station device 20 via the baseband signal processing unit 82, the wireless signal processing unit 81, the antenna Ant1, the base station (for example, the base station eNB1), and the local GW device 10.

The operation unit 89 receives an operation performed by a user who owns the terminal UE1 (for example, an instruction for starting utilization of an application using the local cellular network LCNW). Also, in a case in which the terminal UE1 is a smartphone or a tablet terminal, the operation unit 89 may form a touch panel along with the terminal display unit 85.

The position information acquisition unit GP receives a plurality of signals indicating clock times sent from a plurality of navigation satellites (that is, global positioning system (GPS) satellites) and positions (coordinates) of the respective GPS satellites. The position information acquisition unit GP calculates the position of the terminal UE1 on the basis of the received plurality of signals. The position information acquisition unit GP outputs position information of the terminal UE1 to the baseband signal processing unit 82.

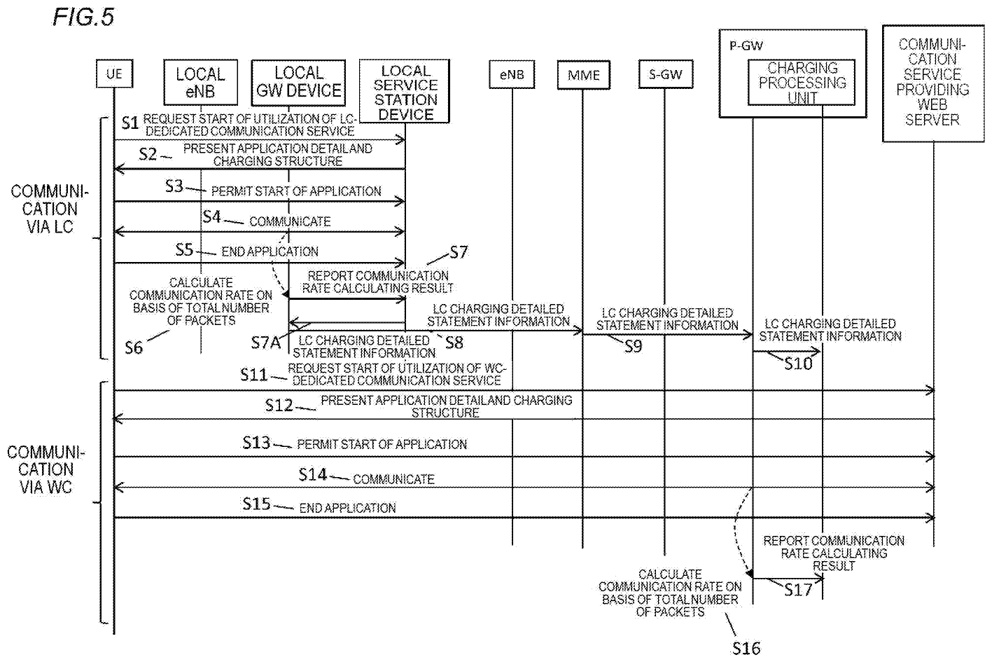

FIG. 5 is a sequence diagram illustrating an example of signaling for each communication service that a terminal in the communication charging system 100 according to the embodiment has used.

FIG. 5 illustrates an operation procedure in a case in which the terminal (for example, the terminal UE1) uses an application that accompanies communication via LC (that is, the local cellular network LCNW) and an operation procedure in a case in which the terminal (for example, the terminal UE1) uses an application that accompanies communication via WC (that ism the wide cellular network WCNW), respectively. The former application is a communication service that the terminal (for example, the terminal UE1) downloads charged textbook data necessary for university classes in a university campus in which the local cellular network LCNW is constructed, for example. Meanwhile, the latter application is a communication service that a terminal (for example, the terminal UE1) that a user owns calls an IP phone call to a terminal owned by a user's father who is in a parent home of the user.

In FIG. 5, it is assumed that an instruction for requesting start of utilization of an LC (that is, the local cellular network LCNW)-dedicated communication service has been provided to the terminal UE1 through an operation of the user who owns the terminal UE1 (S1; see FIG. 6). The terminal UE1 transmits a request for starting utilization of the communication service indicated by the instruction to the local service station device 20 (S1). The request for starting the utilization of the communication service is received by the local service station device 20 via the application processing unit 88, the baseband signal processing unit 82, the wireless signal processing unit 81, the antenna Ant1, the base station (for example, the base station eNB1), and the local GW device 10.

FIG. 6 is a diagram illustrating an example of an application selecting screen WD1 displayed on the terminal display unit 85 of the terminal UE1 and an application start permission selecting screen WD2 corresponding to a selected application according to the embodiment. In Step S1, for example, an instruction for activating and starting a communication service (for example, an application C) that can be used using the local cellular network LCNW, which is provided with a user's finger FG, is received as illustrated on the left side of the paper in FIG. 6.

If the request for starting the utilization of the communication service (for example, the application C) transmitted from the terminal UE1 in Step S1 is received, the local service station device 20 acquires detailed information of the application C and charging structure information that accompanies the utilization of the application C. The local service station device 20 transmits the acquired detailed information of the application C and the charging structure information that accompanies the utilization of the application C in an associated manner to the terminal UE1 (S2). The detailed information of the application C and the charging structure information that accompanies the utilization of the application C are transmitted to the terminal (for example, the terminal UE1) via the local GW device 10 and the base station (for example, the base station eNB1).

The terminal UE1 receives the detailed information of the application C and the charging structure information that accompanies the utilization of the application C, which are transmitted from the local service station device 20 in Step S2. The terminal UE1 generates the application start permission selecting screen WD2 using the received detailed information of the application C and the charging structure information that accompanies the utilization of the application C and displays the application start permission selecting screen WD2 on the terminal display unit 85.

As illustrated on the right side of the paper in FIG. 6, the application start permission selecting screen WD2 is a screen on which a name of the application C, a name KK of a subject that provides the communication service of the application C that the terminal UE1 uses, charging structure information PP that accompanies the utilization of the application C, and a permission selecting item for allowing selection regarding whether to permit or interrupt start of the application C are displayed. Also, in a case in which information regarding the cumulative amount of packet utilization (the amount of communication) of this month has been acquired from the local GW device 10, the terminal (for example, the terminal UE1) may perform display including the information regarding the cumulative amount when the application start permission selecting screen WD2 is displayed. In this manner, the user can give up further excessive utilization of the application by viewing the amount of packet utilization and can avoid being charged for a very expensive rate.

Also, the terminal (for example, the terminal UE1) may decide either the local cellular network LCNW or the wide cellular network WCNW as a network that can be used for position information of the terminal (in other words, position information of the user who owns the terminal) on the basis of an output from the position information acquisition unit GP. In this manner, the terminal (for example, the terminal UE1) can easily generate the application start permission selecting screen WD2 in accordance with the result of the decision.

FIG. 7 is a diagram illustrating candidate examples of communication service providers, communication services, and charging structures to be displayed on the application start permission selecting screen WD2 illustrated in FIG. 6. Candidates of names KK of subjects that provide communication services are, for example, a wide-range cellular system communication service provider AA, a cellular system communication service provider BB, and a cellular system communication service provider CC, which are existing wide-range cellular communication service providers, and further, a local area communication service provider DD and a local area communication service provider EE, which are newcomer solution providers. Candidates of names of applications are, for example, video uploading, video downloading, constructing machine remote manipulation, teleconference, Internet accesses, calls (inside a local area), and calls (outside the local area). Candidates of charging structure information that accompanies utilization of the applications are, for example, free of charge, 1000 JPY/1 GB (gigabyte), 200 JPY/1 GB, and 10 JPY/1 GB.

It is assumed that the terminal UE1 has received an instruction indicating permission of start of an application C through an operation performed with a user's finger FG on the application start permission selecting screen WD2 (S3). The terminal UE1 transmits information regarding the instruction indicating permission of start of the application C to the local service station device 20 in response to the instruction in Step S3 (S3). The information regarding the instruction indicating permission of start of the application C is received by the local service station device 20 via the application start permission/interruption instruction information extracting unit 83, the baseband signal processing unit 82, the wireless signal processing unit 81, the antenna Ant1, the base station (for example, the base station eNB1), and the local GW device 10.

The local service station device 20 performs wireless communication that accompanies the utilization of the application C with the terminal UE1 on the basis of the reception of the information regarding the instruction indicating permission of start of the application C, which has been transmitted from the terminal UE1 in Step S3 (S4). The wireless communication between the local service station device 20 and the terminal UE1 in Step S4 is performed via the local GW device 10 and the base station (for example, the base station eNB1).

The local GW device 10 measures and manages the amount of communication indicating the total number of packets in relation to wireless communication on uplink and the amount of communication indicating the number of packets in relation to wireless communication on downlink during the wireless communication that accompanies the utilization of the application C between the local service station device 20 and the terminal UE1 in Step S4.

Here, it is assumed that an instruction indicating ending of the utilization of the application C has been provided through a user's operation, and the instruction has been transmitted to the local service station device 20 through a communication route that is similar to that in Step S3, or that an instruction indicating ending of the utilization of the application C has been transmitted from the local service station device 20 to the terminal UE1 through a communication route that is similar to that in Step S2. In this case, the wireless communication that accompanies the application C ends between the terminal UE1 and the local service station device 20 (S5).

After Step S5, the local GW device 10 calculates a communication rate caused when the terminal UE1 uses the application C and generates LC charging information on the basis of a result of measuring the amount of communication indicating the total number of packets that have used and passed through the uplink and a result of measuring the amount of communication indicating the total number of packets that have used and passed through the downlink, which have been measured in Step S4, and the charging structure information of the application C (S6). The local GW device 10 transmits and reports the LC charging information (that is, the result of calculating the communication rate in accordance with the total number of packets caused when the application C is used) generated in Step S6 to the local service station device 20 (S7).

After the LC charging information transmitted from the local GW device 10 is received in Step S7, the local service station device 20 generates detailed statement data (LC charging detailed statement information) of the communication rate for the user of the terminal UE1 with which the application C has been used, on the basis of the LC charging information. The local service station device 20 transmits the generated detailed statement data (LC charging detailed statement information) of the communication rate to the local GW device 10 (S7A).

After the LC charging detailed statement information transmitted from the local service station device 20 is received in Step S7A, the local GW device 10 transmits the LC charging detailed statement information to the MME 50 of the wide cellular network WCNW (S8). The MME 50 transmits the LC charging detailed statement information transmitted from the local GW device 10 in Step S8 to the P-GW 70 via the S-GW 60 (S9). The P-GW 70 passes the LC charging detailed statement information transmitted from the MME 50 in Step S9 to the charging processing unit 75 (S10).

Next, it is assumed that an instruction for requesting a start of utilization of a communication service in WC (that is, the wide cellular network WCNW) has been provided to the terminal UE1 through an operation performed by the user who owns the terminal UE1 (see S11). The terminal UE1 transmits a request for starting utilization of the communication service indicated by the instruction to the communication service providing web server (not illustrated) (S11). The request for starting the utilization of the communication service is received by the communication service providing web server (not illustrated) via the application processing unit 88, the baseband signal processing unit 82, the wireless signal processing unit 81, the antenna Ant1, the base station (for example, the base station eNB3), the MME 50 or the S-GW 60, the P-GW 70, and the network NW1.

After a request for starting utilization of a communication service (for example, a phone call (outside the local area) corresponding to the application D) transmitted from the terminal UE1 in Step S11 has been received, the communication service providing web server (not illustrated) acquires detailed information of the application D and charging structure information that accompanies the utilization of the application D. The communication service providing web server (not illustrated) transmits the acquired detailed information of the application D and the charging structure information that accompanies the utilization of the application D in an associated manner to the terminal UE1 (S12). The detailed information of the application D and the charging structure information that accompanies the utilization of the application D are transmitted to the terminal (for example, the terminal UE1) via the communication service providing web server (not illustrated), the network NW1, the P-GW 70, the S-GW 60 or the MME 50, and the base station (for example, the base station eNB3).

The terminal UE1 receives the detailed information of the application D and the charging structure information that accompanies the utilization of the application D, which have been transmitted from the communication service providing web server (not illustrated) in Step S12. The terminal UE1 generates an application start permission selecting screen (see FIG. 6) using the received detailed information of the application D and the charging structure information that accompanies the utilization of the application D and displays the application start permission selecting screen on the terminal display unit 85.

It is assumed that the terminal UE1 has received an instruction indicating permission of start of the application D through an operation performed with the user's finger FG on the application start permission selecting screen displayed on the terminal display unit 85 (S13). The terminal UE1 transmits information regarding the instruction indicating the permission of the start of the application D to the communication service providing web server (not illustrated) in response to the instruction in Step S13 (S13). The information regarding the instruction indicating the permission of the start of the application D is received by the communication service providing web server (not illustrated) via the application start permission/interruption instruction information extracting unit 83, the baseband signal processing unit 82, the wireless signal processing unit 81, the antenna Ant1, the base station (for example, the base station eNB3), the MME 50 or the S-GW 60, the P-GW 70, and the network NW1.

The communication service providing web server (not illustrated) performs wireless communication that accompanies the utilization of the application D with the terminal UE1 on the basis of the reception of the information regarding the instruction indicating the permission of the start of the application D, which has been transmitted from the terminal UE1 in Step S13 (S14). The wireless communication between the communication service providing web server (not illustrated) and the terminal UE1 in Step S14 is performed via the network NW1, the P-GW 70, the S-GW 60 or the MME 50, and the base station (for example, the base station eNB3).

The charging processing unit 75 measures and manages the amount of communication indicating the total number of packets in relation to wireless communication on uplink and the amount of communication indicating the total amount of packets in relation to wireless communication on downlink during the wireless communication that accompanies the utilization of the application D between the communication service providing web server (not illustrated) and the terminal UE1 in Step S14, respectively.

Here, it is assumed that an instruction for ending the utilization of the application D has been provided through a user's operation and the instruction has been transmitted to the communication service providing web server (not illustrated) through a communication route that is similar to that in Step S13, or that an instruction for ending the utilization of the application D has been transmitted to the terminal UE1 through a communication route that is similar to that in Step S12 by the communication service providing web server (not illustrated). In this case, the wireless communication that accompanies the application D ends between the terminal UE1 and the communication service providing web server (not illustrated) (S15).

After Step S15, the charging processing unit 75 calculates a communication rate caused when the terminal UE1 uses the application D and generates WC charging information on the basis of the result of measuring the amount of communication indicating the total number of packets that have used and passed through the uplink and the result of measuring the amount of communication indicating the total number of packets that have used and passed through the downlink, which have been measured in Step S14, and the charging structure information of the application D (S16). The charging processing unit 75 generates detailed statement data (WC charging detailed statement information) of the communication rate for the user of the terminal UE1 with which the application D has been used, on the basis of the generated WC charging information.

Also, although not illustrated in FIG. 5, the charging processing unit 75 may generate, for each terminal, terminal charging detailed statement information that collectively includes the LC charging detailed statement information acquired in Step S10 and the aforementioned WC charging detailed statement information. The charging processing unit 75 may transmit the terminal charging detailed statement information generated for each terminal to the corresponding terminal (for example, the terminal UE1) as a notification. In this manner, the communication service provider (for example, an existing wide-range cellular communication service provider) that runs the wide cellular network WCNW can distinguish and manage utilization of a communication service in the local cellular network LCNW and utilization of a communication service in the wide cellular network WCNW and collectively charges the user who owns the terminal for the communication rate based on the LC charging detailed statement information and the communication rate based on the WC charging detailed statement information.

As described above, the local GW device 10 (an example of the first measuring device) measures the amount of communication established by a terminal (for example, the terminal UE1) in utilization of a communication service (an example of the first communication service) using the local cellular network LCNW (an example of the first communication network) in the communication charging system 100 according to the embodiment. The P-GW 70 (an example of the second measuring device) measures the amount of communication established by the terminal (for example, the terminal UE1) in utilization of a communication service (an example of the second communication service) using the wide cellular network WCNW (an example of the second communication network). The local GW device 10 transmits information regarding the measured amount of communication in the utilization of the communication service in the local cellular network LCNW to the P-GW 70 via the MME 50 and the S-GW 60. The P-GW 70 associates and stores information regarding the amount of communication in the utilization of the communication service, which has been transmitted from the local GW device 10, and information regarding the amount of communication in the utilization of the communication service, which has been measured by the P-GW 70, with information regarding the terminal (for example, the terminal UE1) in the memory 77 (an example of the storage unit).

In this manner, the communication charging system 100 according to the embodiment can measure and manage the amount of communication in accordance with traffics of wireless communication for each of communication service in the local cellular network LCNW and the wide cellular network WCNW, which the terminal (for example, the terminal UE1) owned by the user has performed. Therefore, the communication charging system 100 can realize appropriate charging on the user for communication services in accordance with situations (for example, situations such as in which of an outdoor area, a local area, and an indoor area the user has used the communication services) when the communication services have been used by the terminal (for example, the terminal UE1) and effectively support distribution of utilization of the communication services to many users.

Also, the P-GW 70 generates charging information (terminal charging detailed statement information) regarding utilization of communication services of the user who owns the terminal (for example, the terminal UE1) using the information regarding the amount of communication in the utilization of the communication service in the local cellular network LCNW and the information regarding the amount of communication in the utilization of the communication service in the wide cellular network WCNW, which are stored in the memory 77. In this manner, the communication service provider (for example, an existing wide-range cellular communication service provider) that runs the wide cellular network WCNW can distinguish and manage a rate for using the communication service in the local cellular network LCNW and a rate for using the communication service in the wide cellular network WCNW for each user who owns the terminal.

Also, the P-GW 70 may provide, as a notification, the terminal charging detailed statement information including the LC charging detailed statement information and the WC charging detailed statement information generated for each terminal to the corresponding terminal (for example, the terminal UE1). In this manner, the communication service provider (for example, an existing wide-range cellular communication service provider) that runs the wide cellular network WCNW, for example, can distinguish and manage utilization of the communication service in the local cellular network LCNW and utilization of the communication service in the wide cellular network WCNW and collectively charge the user who owns the terminal for the communication rate based on the LC charging detailed statement information and the communication rate based on the WC charging detailed statement information.

Also, the local GW device 10 measures the amount of communication established by the terminal (for example, the terminal UE1) in utilization of a communication service (for example, downloading of charged video content data) using a downlink in the local cellular network LCNW, for example. The P-GW 70 measures the amount of communication established by the terminal (for example, the terminal UE10 in the utilization of a communication service (for example, streaming distribution of free video content) on downlink in the wide cellular network WCNW, for example. In this manner, the local GW device 10 can properly calculate a communication rate corresponding to the amount of communication adapted for the charging structure information of the communication service for which the terminal (for example, the terminal UE1) has used the downlink in the local cellular network LCNW. Similarly, the P-GW 70 can properly calculate a communication rate corresponding to the amount of communication adapted for the charging structure information of the communication service for which the terminal (for example, the terminal UE1) has used the uplink in the wide cellular network WCNW.

Also, the local GW device 10 measures the amount of communication established by the terminal (for example, the terminal UE1) in utilization of a communication service (for example, uploading of a university report data) on uplink in the local cellular network LCNW, for example. The P-GW 70 measures the amount of communication established by the terminal (for example, the terminal UE1) in utilization of a communication service (for example, uploading of self-capturing video data) on uplink in the wide cellular network WCNW, for example. In this manner, the local GW device 10 can properly calculate a communication rate corresponding to the amount of communication adapted for the charging structure information of the communication service for which the terminal (for example, the terminal UE1) has used the uplink in the local cellular network LCNW. Similarly, the P-GW 70 can properly calculate a communication rate corresponding to the amount of communication adapted for the charging structure information of the communication service for which the terminal (for example, the terminal UE1) has used the uplink in the wide cellular network WCNW.

Also, the first communication network is a local network (that is, a local cellular network LCNW) in which a communication service can be used in a predetermined area thereof via a base station (for example, the base station eNB1) deployed in the predetermined area (for example, a local area or an indoor area). Also, the second communication network is a wide-range cellular network to which so-called 3G (third generation mobile communication system) or 4G such as LTE or LTE-Advanced can also be applied. In this manner, the terminal (for example, the terminal UE1) that accesses the communication charging system 100 can receive a communication service that can be used only in the local area or the indoor area in which the local cellular network LCNW has been constructed. Meanwhile, the terminal (for example, the terminal UE1) can receive a communication service that cannot be used in the local cellular network LCNW and that can still be used in an area of the wide cellular network WCNW (that is, an outdoor area) and can select a communication service that can be used on a case-by-case basis in accordance with a peripheral environment such as a position of the user.

Also, the terminal (for example, the terminal UE1) receives, at the operation unit 89, an instruction for starting utilization of a communication service (an example of the first communication service) using the local cellular network LCNW. The terminal (for example, the terminal UE1) transmits, using the wireless signal processing unit 81 (an example of the communication unit) to which the antenna Ant1, information regarding the communication service indicated by the instruction to the local service station device 20 (an example of the service station device) that provides the communication service. In addition, the terminal (for example, the terminal UE1) acquires, using the application/charging structure information extracting unit 84 (an example of the acquisition unit) detailed information of the application and the charging structure information indicating a correspondence between the amount of communication in utilization of the communication service and the communication rate, which have been generated by the local service station device 20 on the basis of the information regarding the communication service. The terminal (for example, the terminal UE1) displays, on the terminal display unit 85, the application start permission selecting screen WD2 (an example of the communication service utilization start permission selecting screen) including the acquired detailed information of the application and the charging structure information corresponding to the communication service. The terminal (for example, the terminal UE1) starts communication (that is, utilization of an application) regarding a communication service with the local service station device 20 in response to the instruction for permitting the start of the utilization of the communication service performed by the user's operation on the application start permission selecting screen WD2.

In this manner, the terminal (for example, the terminal UE1) that accesses the communication charging system 100 (the local cellular network LCNW, for example) can present the information regarding the communication rate for the communication service to the user in advance before the user actually starts the communication service, which the user is about to start to use. Therefore, the terminal (for example, the terminal UE1) can start to use the communication service after allowing the user to recognize the information regarding the communication rate and can effectively support distribution of the utilization of the communication service to the user.

### Modification Example of Embodiment

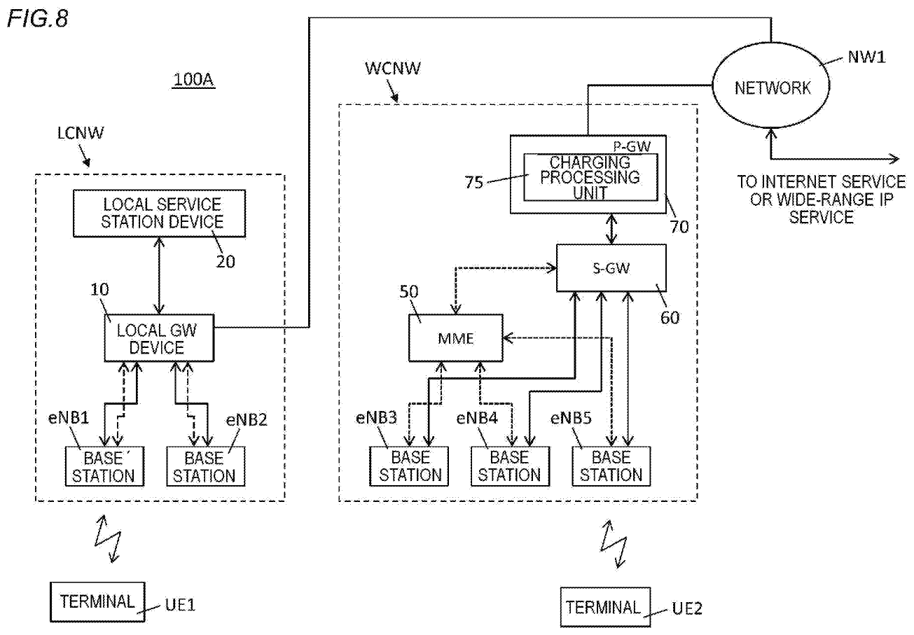

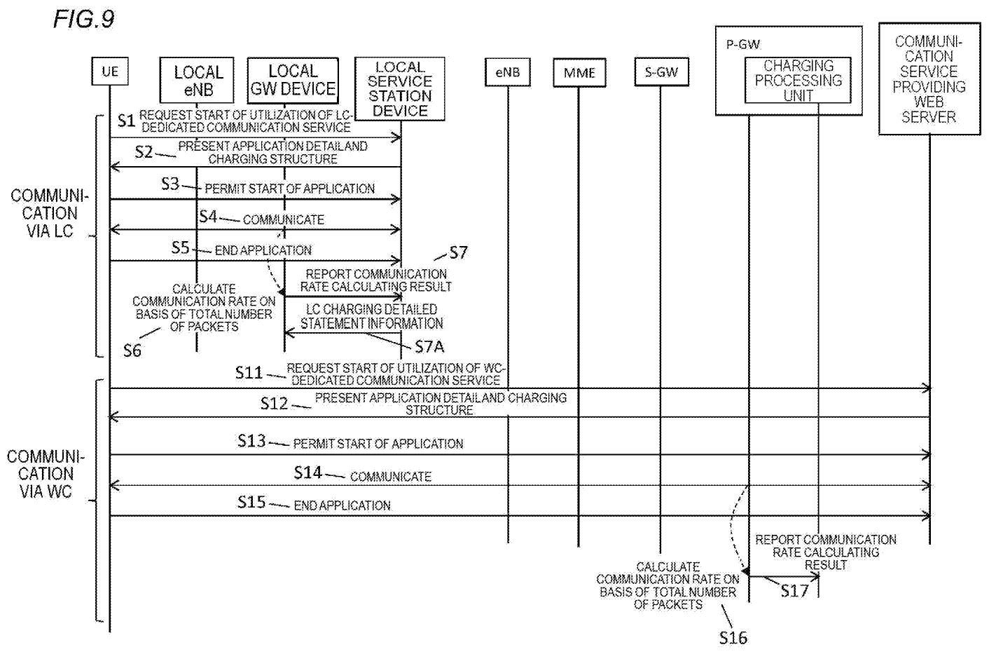

FIG. 8 is a block diagram illustrating a system configuration example of a communication charging system 100A according to a modification example of the embodiment. FIG. 9 is a sequence diagram illustrating an example of signaling for each communication service that a terminal in the communication charging system 100A has used according to the modification example of the embodiment.

According to the modification example of the embodiment, a communication service provider that is a subject providing a communication service that can be used in the local cellular network LCNW individually charges a user for a communication rate that accompanies utilization of a communication service that the communication service provider itself runs, unlike the aforementioned embodiment. Further, a communication service provider that is a subject providing a communication service that can be used in the wide cellular network WCNW individually charges a user for a communication rate that accompanies utilization of a communication service that the communication service provider itself runs.

Since the configuration of the communication charging system 100A illustrated in FIG. 8 is similar to the configuration of the communication charging system 100 illustrated in FIG. 1, the same reference numerals are applied to the configurations with the same details, description thereof will be simplified or omitted, and different details will be described. Also, the same step numbers will be applied to details that are the same as those in the description of FIG. 5 for description of FIG. 9, and description thereof will be simplified or omitted.

According to the modification example of the embodiment, the user who owns the terminal (for example, the terminal UE1) is individually charged for the LC charging information (in other words, the communication rate corresponding to the amount of communication for the communication service used in the local cellular network) by the communication service provider that is the subject providing the communication service that can be used in the local cellular network LCNW, as described above. Therefore, the LC charging detailed statement information is not transmitted and received between the local GW device 10 and the MME 50 in FIGS. 8 and 9.

As described above, the local GW device (an example of the first measuring device) measures the amount of communication established by the terminal (for example, the terminal UE1) in utilization of a communication service (an example of the first communication service) using the local cellular network LCNW (an example of the first communication network) in the communication charging system 100 according to the modification example of the embodiment. The P-GW 70 (an example of the second measuring device) measures the amount of communication established by the terminal (for example, the terminal UE1) in utilization of a communication service (an example of the second communication service) using the wide cellular network WCNW (an example of the second communication network). The local GW device 10 associates and stores information regarding the measured amount of communication in the utilization of the communication service in the local cellular network LCNW with information regarding the terminal (for example, the terminal UE1) in the memory 17 (an example of the first storage unit). The P-GW 70 associates and stores the information regarding the measured amount of communication in the utilization of the communication service in the wide cellular network WCNW with the information regarding the terminal (for example, the terminal UE1) in the memory 77 (an example of the second storage unit).

In this manner, each of the local GW device 10 and the P-GW 70 can measure and manage the amount of communication in accordance with traffics of wireless communication for each of the communication services in the local cellular network LCNW and the wide cellular network WCNW, which have been performed with the terminal (for example, the terminal UE1) owned by the user, in the communication charging system 100 according to the modification example of the embodiment. Therefore, each of the local GW device 10 and the P-GW 70 can individually recognize appropriate charging on the user for the communication services in accordance with situations when the terminal (for example, the terminal UE1) has used the communication services (for example, situations such as in which of an outdoor area, a local area, and an indoor area the user has used the communication services) and effectively support distribution of the communication services to many users.

Although various embodiments have been described above with reference to the drawings, it is needless to say that the present disclosure are not limited to such examples. It is obvious for those skilled in the art that various modification examples and correction examples can be achieved within the scope described in the claims, and it is a matter of course that the modification examples and the correction examples also belong to the technical scope of the present disclosure. In addition, the respective components in the aforementioned embodiments can be in any manner without departing from the gist of the invention.

The present application is based on Japanese Patent Application No. 2017-184216 filed on Sep. 25, 2017, the contents of which are incorporated herein for reference.

### INDUSTRIAL APPLICABILITY

The present disclosure is useful as a communication charging system and a communication charging method that measure and manage the amount of communication in accordance with traffics of wireless communication for each of communication service performed by a terminal owned by a user, realize appropriate charging for the communication service in accordance with situations during the utilization, and effectively support distribution of utilization of the communication service to users.

The present disclosure is useful as a terminal that present information regarding a communication rate for a communication service that a user is about to start to use to the user in advance, allows the user to recognize the information regarding the communication rate before starting the utilization, and thus effectively support distribution of utilization of the communication service to users.

### REFERENCE SIGNS LIST

10: Local GW device
11: MME processing unit
12: HSS processing unit
13: S-GW processing unit
14: P-GW processing unit
15: PCRF processing unit
16: Charging processing unit
17, 24, 77, 86: Memory
20: Local service station device
21: Communication rate invoice generation unit
22: Application server processing unit
23: Service signal processing unit
50: MME
60: S-GW
70: P-GW
75: Charging processing unit
81: Wireless signal processing unit
82: Baseband signal processing unit
83: Application start permission/interruption instruction information extracting unit
84: Application/charging structure information extracting unit
85: Terminal display unit
87: User data input and output I/F unit
88: Application processing unit
89: Operation unit
100: Communication charging system
141: Uplink packet number counting unit
142: Downlink packet number counting unit
Ant1: Antenna
eNB1, eNB2, eNB3, eNB4, eNB5: Base Station
GP: Position information acquisition unit
NW1, NW2: Network
LCNW: Local cellular network
TBL1: Application charging structure table
UE1, UE2: Terminal
WCNW: Wide cellular network

1. A communication charging system comprising:
a first measuring device that measures an amount of communication established by a terminal in utilization of a first communication service using a first communication network; and
a second measuring device that measures an amount of communication established by the terminal in utilization of a second communication service using a second communication network, wherein
the first measuring device transmits information regarding the measured amount of communication in the utilization of the first communication service to the second measuring device, and
the second measuring device associates with information regarding the terminal and stores, in a storage unit, the information regarding the amount of communication in the utilization of the first communication service, which has been transmitted from the first measuring device, and information regarding the measured amount of communication in the utilization of the second communication service.

2. The communication charging system according to claim 1, wherein
the first measuring device measures the amount of communication established by the terminal in the utilization of the first communication service on downlink in the first communication network, and
the second measuring device measures the amount of communication established by the terminal in the utilization of the second communication service on downlink in the second communication network.

3. The communication charging system according to claim 1, wherein
the first measuring device measures the amount of communication established by the terminal in the utilization of the first communication service on uplink in the first communication network, and
the second measuring device measures the amount of communication established by the terminal in the utilization of the second communication service on uplink in the second communication network.

4. The communication charging system according to claim 1, wherein the second measuring device generates charging information regarding utilization of communication services of a user who owns the terminal using the information regarding the amount of communication in the utilization of the first communication service and the information regarding the amount of communication in the utilization of the second communication service, which are stored in the storage unit.

5. The communication charging system according to claim 4, wherein
the first measuring device measures the amount of communication established by the terminal in the utilization of the first communication service on downlink in the first communication network, and
the second measuring device measures the amount of communication established by the terminal in the utilization of the second communication service on downlink in the second communication network.

6. The communication charging system according to claim 4, wherein
the first measuring device measures the amount of communication established by the terminal in the utilization of the first communication service on uplink in the first communication network, and
the second measuring device measures the amount of communication established by the terminal in the utilization of the second communication service on uplink in the second communication network.

7. The communication charging system according to claim 4, wherein the second measuring device provides a notification of the generated charging information to the terminal.

8. The communication charging system according to claim 7, wherein
the first measuring device measures the amount of communication established by the terminal in the utilization of the first communication service on uplink in the first communication network, and
the second measuring device measures the amount of communication established by the terminal in the utilization of the second communication service on uplink in the second communication network.

9. The communication charging system according to claim 1, wherein
the first communication network is a local network in which the first communication service can be used in a predetermined area via a base station deployed in the predetermined area, and
the second communication network is a wide-range cellular network.

10. A communication charging method using a communication charging system that includes a first measuring device and a second measuring device, the communication method comprising:
by the first measuring device, measuring an amount of communication established by a terminal in utilization of a first communication service using a first communication network;
by the second measuring device, measuring an amount of communication established by the terminal in utilization of a second communication service using a second communication network;
by the first measuring device, transmitting information regarding the measured amount of communication in the utilization of the first communication service to the second measuring device; and
by the second measuring device, associating and storing, in a storage unit, the information regarding the amount of communication in the utilization of the first communication service, which has been transmitted from the first measuring device, and information regarding the measured amount of communication in the utilization of the second communication service with information regarding the terminal.

11. A communication charging system comprising:
a first measuring device that measures an amount of communication established by a terminal in utilization of a first communication service using a first communication network; and
a second measuring device that measures an amount of communication established by the terminal in utilization of a second communication service using a second communication network, wherein
the first measuring device associates and stores, in a first storage unit, information regarding the measured amount of communication in the utilization of the first communication service with information regarding the terminal, and
the second measuring device associates and stores, in a second storage unit, information regarding the measured amount of communication in the utilization of the second communication service with the information regarding the terminal.

12. A communication charging method using a communication charging system that includes a first measuring device and a second measuring device, the communication charging method comprising:
by the first measuring device, measuring an amount of communication established by a terminal in utilization of a first communication service using a first communication network;
by the second measuring device, measuring an amount of communication established by the terminal in utilization of a second communication service using a second communication network;
by the first measuring device, associating and storing, in a first storage unit, information regarding the measured amount of communication in the utilization of the first communication service with information regarding the terminal; and
by the second measuring device, associating and storing, in a second storage unit, information regarding the measured amount of communication in the utilization of the second communication service with the information regarding the terminal.
